(19) United States
(12) Patent Application Publication
(10) Pub. No.: US 2015/0120614 A1
(43) Pub. Date: Apr. 30, 2015

(54) SYSTEMS AND METHODS FOR OPTIMIZING PRODUCT PRICES

(71) Applicant: W.W. GRAINGER, INC., Lake Forest, IL (US)

(72) Inventor: Geoffry A. Westphal, Evanston, IL (US)

(73) Assignee: W.W. GRAINGER, INC., Lake Forest, IL (US)

(21) Appl. No.: 14/062,441

(22) Filed: Oct. 24, 2013

(51) Int. Cl. G06Q 30/02

(52) U.S. Cl. CPC G06Q 30/0283
USPC 705/400

(57) ABSTRACT

Systems and methods are provided for optimizing prices for products and services based on consumer survey data, or at least based on the principle that non-flat prices such as $0.99, $3.95, $49.99, for example, create negative impressions about merchants. The system may retrieve a current price from a database and identify a price class or a price range to which the current price corresponds. The system may then execute a pricing process that is associated with the identified price class or price range. The pricing process computes an offer price that a majority of consumers will perceive as being more fair than the current price.

### FIELD OF THE DISCLOSURE

The present disclosure relates generally to automated product pricing and, more particularly, to systems and methods for optimizing prices at which products or services are sold and offered for sale.

### BACKGROUND OF RELATED ART

It is known that merchants and service providers use a variety of pricing strategies when marketing goods and/or services to consumers. One such pricing strategy that has been in widespread use for decades is “psychological pricing,” sometimes referred to as “charm pricing.” Psychological pricing involves setting prices slightly less than round numbers so that consumers perceive these prices as being significantly lower than they actually are. Psychological pricing is based on the principle that certain prices make a psychological impact on consumers. That impact causes consumers to associate a price such as $1.99 with $1.00 rather than $2.00. As merchants realize, lower prices oftentimes increase demand. Thus, merchants hope to sell more product as a result of prices that appear lower than they really are.

One theory on which psychological pricing is based is that consumers ignore the least-significant digits, which oftentimes amounts to cents, but in other cases can amount to dollars, tens of dollars, hundreds of dollars, etc. Another theory is based on a “left-digit anchoring effect,” where judgments about differences in numbers are anchored on the leftmost digit. Still another theory is that consumers see fractional prices as representing the lowest possible price for a product.

Regardless of the theories on which psychological pricing is based, research has also shown that a percentage of consumers have negative perceptions of prices that end in “0.99,” “0.95,” or “0.49,” for example. Researchers have discovered the same for odd dollar amounts for larger prices such as $995, for example. Some consumers indicate that they are well aware of and are frustrated by psychological pricing tactics. Such tactics, consumers say, are perceived as dishonest, tricky, deceptive, and “hard to add.” By contrast, consumer surveys have shown that consumers associate goodwill with merchants that sell products at flat numbers and/or multiples of denominations of currency, such as $2.40, $13.25, or $57.00, for example. Prices such as these create the perception that a merchant is being straightforward with its pricing strategy and not trying to mislead consumers or complicate the buying process.

As of now, however, there is no way of optimizing the prices at which merchants sell product, other than manually, on a product by product basis.

### BRIEF DESCRIPTION OF THE DRAWINGS

For a better understanding of the disclosed system and methods for optimizing product prices, reference may be had to examples shown in the following drawings.

FIG. 1 is a block diagram illustrating components of an example system that may be utilized to optimize product prices.

FIG. 2 is a flowchart of an example method in which the example system of FIG. 1 may optimize product prices.

### DETAILED DESCRIPTION

To address the aforementioned need and other needs, disclosed hereinafter are example systems and methods for optimizing prices at which products are sold and offered for sale. The system may in some examples identify a user of a merchant's website and load a pricing template for one or more categories of consumers with which the user is associated. The system may identify a price class, a price range, or a combination price class-price range to which a current price belongs. The system may then execute a pricing process associated with the identified price class, price range, or combination price class-price range. The pricing process optimizes the current price to an offer price that is less likely to make a negative impression about the merchant, and/or is perceived by consumers as being more fair.

The following description of example systems and methods is not intended to limit the scope of the disclosure to the precise form or forms detailed herein. Instead the following disclosure is intended to be illustrative so that others may follow its teachings.

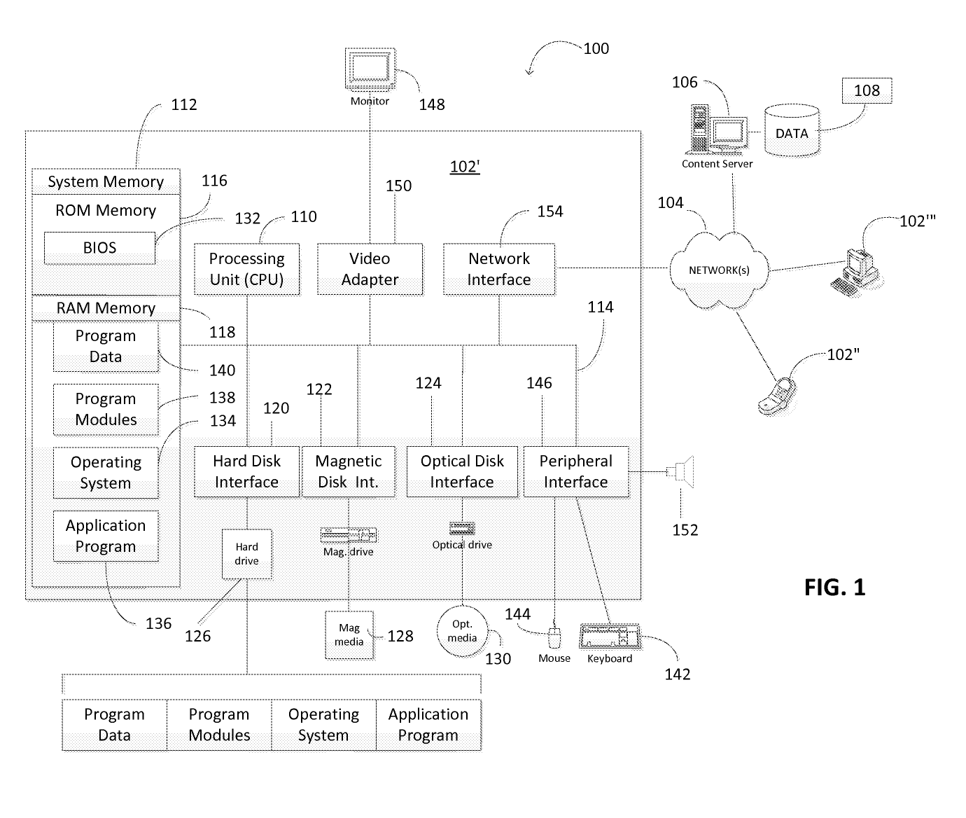

As illustrated in FIG. 1, a system 100 will be described in the context of a plurality of example processing devices 102 linked via a network 104, such as a proprietary network, intranet, the World Wide Web, and/or the Internet. In this regard, a user processing device 102′ illustrated in the example form of a computer system, a user processing device 102″ illustrated in the example form of a mobile device, or a user processing device 102′″ illustrated in the example form of a personal computer provide a means for a user to access a website content server 106 via the network 104 and thereby gain access to content such as media, data, webpages, an electronic catalog, etc., stored in a repository 108 associated with the content server 106. Although only one of the processing devices 102 is shown in detail in FIG. 1, it will be understood that in some examples the user processing device 102′ shown in detail may be representative, at least in part, of the other user processing devices 102″, 102′″, including those that are not shown, as well as the content server 106.

Furthermore, the website content server 106 and/or the user processing devices 102 allow users to read and/or write data from/to the website content server 106. A user's interactions with the content offered by a website are stored in the repository 108 associated with the content server 106 and are further indexed to a particular user (e.g., using log-in information, an internet protocol (IP) address, or other information that the content server 106 may utilize to identify the user or at least a device). Storing such information can be accomplished, for example, by monitoring user interactions with a website during web browsing sessions by recording events, accessed content, and other data

In another example, the information about the user and/or the user's interactions with the content offered by the website may also or alternatively be stored on the user processing devices 102 and/or other storage media local to the device 102, for example, in cases where a user has not logged into the website content server 106 and is anonymously navigating the content provided by the website content server 106. In this case, users' interactions with the web content offered by the website content server 106 may be stored, for example, in cookies placed on the user processing devices 102 using well known techniques. Because the manner by which the user processing devices 102 are used to access and navigate the website offered by the website content server 106, the manner by which the website content server 106 makes content available to the user devices 102, and the manner by which the website usage is monitored—are all well known in the art, they will not be discussed further herein for the sake of brevity.

For performing the functions required of the user processing devices 102 and the content server 106, the user processing devices 102 and the content server 106 include computer executable instructions that reside in program modules stored on any non-transitory computer readable storage media that may include routines, programs, objects, components, data structures, etc. that perform particular tasks or implement particular abstract data types. Accordingly, one of ordinary skill in the art will appreciate that the user processing devices 102 and the content server 106 may be any device having the ability to execute instructions such as, by way of example, a personal computer, mainframe computer, personal-digital assistant (PDA), tablet, cellular telephone, mobile device, e-reader, or the like. Furthermore, while the user processing devices 102 and the content server 106 within the system 100 are illustrated as respective single devices, those having ordinary skill in the art will also appreciate that the various tasks described hereinafter may be practiced in a distributed environment involving multiple processing devices linked via a local or wide-area network whereby the executable instructions may be associated with and/or executed by one or more of multiple processing devices.

More particularly, the user processing device 102′ performs various tasks in accordance with the executable instructions. Thus the example user processing device 102′ includes one or more processing units 110 and a system memory 112, which may be linked via a bus 114. Without limitation, the bus 114 may be a memory bus, a peripheral bus, and/or a local bus using any of a variety of well-known bus architectures. As needed for any particular purpose, the example system memory 112 includes read only memory (ROM) 116 and/or random access memory (RAM) 118. Additional memory devices may also be made accessible to the processing device 102′ by means of, for example, a hard disk drive interface 120, a removable magnetic disk drive interface 122, and/or an optical disk drive interface 124. As will be understood, these devices, which may be linked to the system bus 114, respectively allow for reading from and writing to a hard drive 126, reading from or writing to a removable magnetic disk 128, and for reading from or writing to a removable optical disk 130, such as a CD/DVD ROM or other optical media. The drive interfaces and their associated tangible, computer-readable media allow for the nonvolatile storage of computer readable instructions, data structures, program modules and other data for the user processing device 102′. Those of ordinary skill in the art will further appreciate that other types of tangible, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 132, containing the basic routines that help to transfer information between elements within the user processing device 102′, such as during start-up, may be stored in the ROM 116. Similarly, the RAM 118, the hard drive 126, and/or the peripheral memory devices may be used to store computer executable instructions comprising an operating system 134, one or more applications programs 136 (such as a Web browser), other program modules 138, and/or program data 140. Still further, computer-executable instructions may be downloaded to one or more of the computing devices as needed, for example, via a network connection.

A user may enter commands and information into the user processing device 102′ through input devices such as a keyboard 142 and/or a pointing device 144 (e.g., a computer mouse). While not illustrated, other input devices may include for example a microphone, a joystick, a game pad, a scanner, a touchpad, a touch screen, a motion sensing input, etc. These and other input devices may be connected to the processing unit 110 by means of an interface 146 which, in turn, may be coupled to the bus 114. Input devices may be connected to the processor 110 using interfaces such as, for example, a parallel port, game port, firewire, universal serial bus (USB), or the like. To receive information from the user processing device 102′, a monitor 148 or other type of display device may also be connected to the bus 114 via an interface, such as a video adapter 150. In addition to the monitor 148, the user processing device 102′ may also include other peripheral output devices such as a speaker 152.

As further illustrated in FIG. 1, the example user processing device 102′ has logical connections to one or more remote computing devices, such as the content server 106 which, as noted above, may include many or all of the elements described above relative to the user processing device 102′ as needed for performing its assigned tasks. By way of further example, the website content server 106 may include executable instructions stored on a non-transient memory device for, among other things, presenting webpages, handling search requests, providing search results, providing access to context related services, redeeming coupons, sending emails, managing lists, managing databases, generating tickets, presenting requested user specific information, generating deals, etc. Communications between the user processing device 102′ and the content server 106 may be exchanged via a further processing device, such as a network router (not shown), that is responsible for network routing. Communications with the network router may be performed via a network interface component 154. Thus within such a networked environment (e.g., the Internet, intranet, World Wide Web, LAN, or other like type of wired or wireless network), it will be appreciated that program modules depicted relative to the user processing device 102′, or portions thereof, may be stored in the repository 108 of the content server 106. Additionally, it will be understood that, in certain circumstances, various data of the application and/or data utilized by the content server 106 and/or the user processing device 102′ may reside in the “cloud.”

In many instances, the website may be associated with a particular merchant, and the user processing device 102′ may correspond to the merchant's computer system. The website may offer products and/or services for sale based on content stored in the content server 106. For the sake of brevity, the present disclosure will refer to the website as selling products. However, those having ordinary skill in the art will appreciate that the example system 100 is equally applicable to merchants offering services, or merchants offering products and services. Likewise, in some examples, a portion of the products offered by a merchant is not necessarily sold via the website. In still other examples, none of the products offered by a merchant is sold via the website. In these examples, the user processing device 102′ is not necessarily connected to the network 104, but rather may be used by the merchant to optimize product prices marketed in printed catalogs, circulars, and/or in-store displays, for example. In such examples, the content associated with each product may be stored in the system memory 112 as opposed to or in addition to the content server 106.

Further, the example system memory 112 of the user processing device 102′ may include a database having one or more data fields for each product offered on the website. At least one of the data fields associated with each product may be a current price. The current price of a product may be computed in a multitude of ways, but in many examples and to many merchants it is generally a function of supply and demand. Moreover, some merchants may employ various pricing strategies to arrive at the current price. For instance, a merchant using psychological pricing may previously have marked-up a product that the merchant is otherwise willing to sell for $4.81, to having a current price of $4.99. While the extent to which different merchants use strategies such as psychological pricing undoubtedly vary widely, it is likely that some merchants unknowingly use strategies like psychological pricing.

To provide a location for the system 100 to store product prices that have been optimized as disclosed below, the example database may in some examples include an offer price data field associated with each product, which may be temporarily stored in some examples, or permanently stored in other examples. In some examples, an offer price for a product may represent a current price that has been optimized by the system 100. As will be understood by those of ordinary skill in the art, the current price may also be called a first price whereas the offer price may also be called a second price. In addition, the database may in some instances also include a data field that corresponds to a minimum price at which a merchant will not offer to sell a product. One example way in which a minimum price may be calculated is by calculating a percentage of the current price. In some instances, though, a merchant may have break-even pricing information on a per-product basis, or may have contractual pricing limits, which may be stored in or supplied to the database.

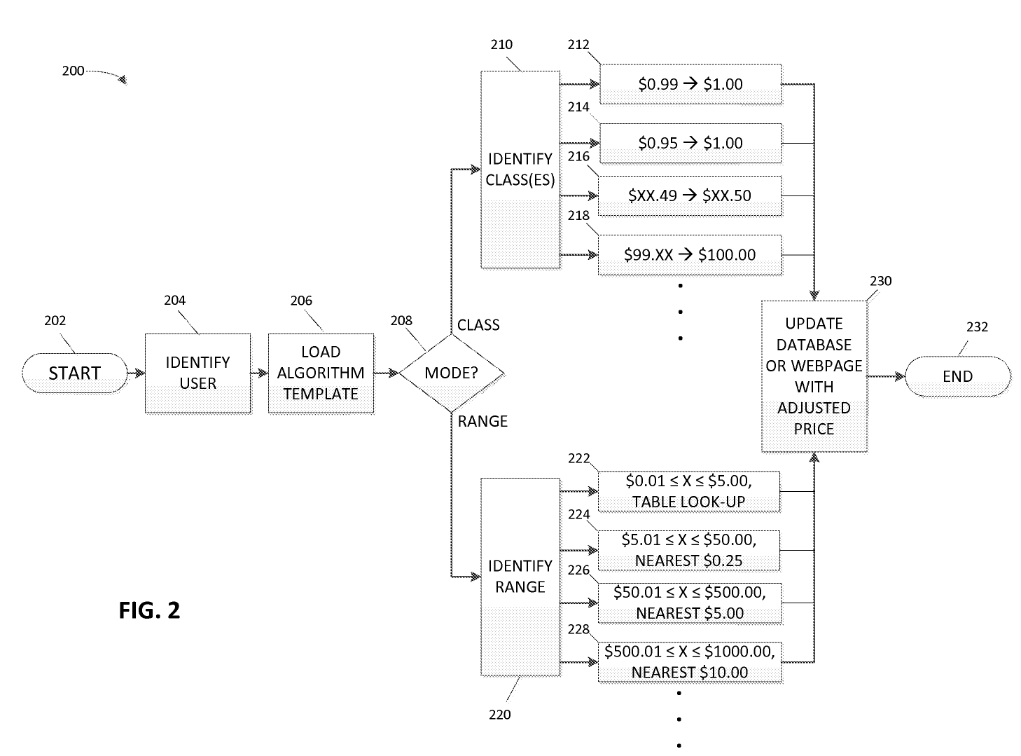

With reference now to FIG. 2, an example method 200 is shown in which the system 100 may optimize product prices on, for example, the processing unit 110. In this particular example, the method 200 may be configured to start 202 when a user of the website requests access to a webpage. However, it should be understood that the system 100 may initiate the optimization process based on a variety of different queues. For instance, in examples where the system 100 is not concerned with the identities of users of the website, the process of optimizing product prices may begin when prompted by an operator of the system 100, automatically when one or more current prices are entered into the database, or when additional consumer data, such as survey data, becomes available.

Furthermore, those having ordinary skill in the art will appreciate that the disclosed method 200 may in some instances occur in real-time or near real-time, for example, as a user of the website requests an offer price of a product offered for sale. In still other cases, though, the disclosed method 200 may occur during an “offline” process or as part of a batch process where offer prices are computed for numerous products. For example, a marketing, finance, or sales group may assign a current price to a product, which is subsequently adjusted by the disclosed method to an offer price. The offer price may then be retrieved when a user of the website requests the offer price. Therefore, the claim limitations do not necessarily need to occur sequentially, but may occur in various sequences depending on the context in which the method 200 is utilized.

In the example method 200, the system 100 identifies the user 204 when the user seeks to load one of the webpages of the website such as a purchasing webpage. The system 100 may use one or more identifiers associated with the user or the user's processing device to identify the user. Example identifiers, as disclosed above, include a user's log-in credentials for the website, cookies, and/or IP address, for instance. In some examples, a particular user processing device may be presumed to be associated with a particular user. If the system 100 can identify the user or the user's processing device, the system 100 may load a pricing template 206 based on the user's identity to be used in the optimization process. Pricing templates may be generated based upon any suitable classification system, including, for example, consumer survey data. The system 100 may select a pricing template most pertinent to one or more category of consumer classification that the user is associated. In some examples, pricing templates may be generated based on consumer survey data, which may be compiled based on surveying different categories of consumers. Several example categories group consumers by gender, geographic region, purchasing history, associated affiliates, industry, age, income, and/or other suitable category. Some categories may be more applicable in business-to-business (B2B) scenarios, while other categories may be more applicable in business-to-consumer (B2C) scenarios.

Nonetheless, consumer survey data may show that consumers in the South and/or in rural areas strongly prefer product prices ending in multiples of $0.25, for example, whereas consumers in the Midwest, East, and/or urban areas strongly prefer prices ending in multiples of $0.10. In such a scenario, the system 100 may generate a different pricing template for each category of consumer: one pricing template to be loaded when the identity of a user suggests that he or she resides in the South or in a rural area, and another pricing template to be loaded when the identity of a user suggests that he or she resides in the Midwest, East, or an urban area. For a category concerning industries, two example ways to identify industries are by Standard Industrial Classification (SIC) codes or by North American Industry Classification System (NAICS) codes. In examples where a user of the website falls into more than one category, the system 100 may generate a hybrid pricing template based on multiple pricing templates, or the system 100 may choose the pricing template associated with the category of consumers that is most pertinent to the user.

As disclosed above, however, in some examples the system 100 does not necessarily load a different pricing template based on the identity of the user. In such examples, the system 100 may be unable to identify the user, or the system 100 may not have enough consumer survey data to generate one of numerous pricing templates. As a result, the system 100 may in some examples skip the steps associated with identifying the user 204 and loading a pricing template 206. In these examples, the system 100 may utilize pricing processes based on uncategorized consumer survey data to optimize product prices as disclosed below. In either case, though, the pricing process(es) that the system 100 executes are based on consumer survey data, or at least the principle that prices such as $0.99, $3.95, $49.99, for example, typically reflect negatively on a merchant.

As shown in the example method 200 of FIG. 2, the system 100 identifies a mode 208 within which to optimize product prices. The mode 208 may be determined by an operator of the system 100, may be set by default, or may be a function of a pricing template, for example. While only two modes are shown here, namely a class mode including pricing processes based on classes and a range mode including pricing processes based on preselected ranges, the system 100 may in other examples use a hybrid mode in which pricing processes are based on combinations of classes and ranges, or a completely different or custom mode as disclosed below. In general, though, the system 100 identifies a class in the class mode and a price range in the range mode.

With respect to a class mode, to identify at least one price class 210 in which the current price belongs, the system 100 may compare a current price of a product or service retrieved from the database to a variety of price class masks. Several examples are shown in the example method 200 of FIG. 2. Each price class mask may encompass a price having at least one of a predetermined dollar value or a predetermined cent value such that the system 100 can identify one or more price classes with which each current price is associated. For instance, if the current price of $0.99 is accessed from the database, for instance, the system 100 may execute a pricing process based on a price class mask having a predetermined dollar value of zero and a predetermined cent value of ninety-nine, thereby adjusting the price to $1.00 in a step 212. This pricing process adjusting the price may be based on consumer survey data reflecting that consumers of one category believe that a price of $1.00 is more fair than a price of $0.99, for instance. In another example, the system 100 may execute a pricing process for adjusting a current price of $0.95 to $1.00 in a step 214 based on a price class mask having a predetermined dollar value of zero and a predetermined cent value of ninety-five. In a further example, in a step 216 the system 100 may execute a pricing process adjusting a current price of $XX.49, based on a price class mask having a predetermined cent value of forty-nine and no predetermined dollar value, to $XX.50. In still another example, the system 100 may execute a pricing process adjusting a current price of $99.XX, based on a price class mask having a predetermined dollar value of ninety-nine and no predetermined cent value, to $100.00 in a step 218. In some examples, the pricing processes may be selected, modified, or defined by an operator of the system 100. Moreover, while each price class has a corresponding pricing process, the pricing processes for each price class are not necessarily unique. By way of example, the same pricing process may operate on a price class directed to $0.95, a price class directed to $0.99, and a price class directed to $1.05.

Those having ordinary skill in the art will understand that the pricing processes shown in FIG. 2 are merely examples. For instance, contrary to the examples shown in FIG. 2, some pricing processes may actually adjust current prices downwards. For instance, the system 100 may adjust a current price of $11.06 to $11.00. Other example pricing processes may adjust amounts such as $X.X1, $X.X2, $X.X7, $X.X8, and $X.X9 and to the nearest ten-cent denomination, while other example pricing processes may adjust amounts such as $X.X3, $X.X4, and $X.X6 to the nearest five-cent denomination. Those having ordinary skill in the art will also understand that current prices may at times fall into more than one price class. For example, a current price of $99.49 may belong to two price classes: one in which a pricing process adjusts the $99.XX to $100.00 and another in which a pricing process adjusts the $XX.49 to $XX.50. One example way in which to resolve such “conflicts” is to prioritize the pricing process performing the larger adjustment and disregard the pricing process attempting to act on the smaller number. Accordingly, in one example a pricing process adjusting dollars would trump a pricing process attempting to adjust cents. Likewise, in another example a pricing process adjusting $X.21 to $X.25 would take priority over a pricing process attempting to adjust $X.X1 to $X.X0. Thus, in the current example, $99.49 would be adjusted to $100.00, and not $99.50 or $100.50. Still another example way to prioritize which of several pricing processes will act on a current price is according to a priority assigned to each price class. Thus a pricing process associated with a price class having a lower priority will be ignored when a current price also belongs to a second price class having a higher priority.

With respect to a range mode, to identify a price range 220 to which the current price belongs, the system 100 may compare a current price to a plurality of price ranges. A current price will necessarily belong to one price range and, thus, be subjected to a corresponding pricing process. Price ranges are distinct from price classes and may encompass a series of prices between an upper limit and a lower limit. One price range, for instance, can encompass prices that are subject to tens, hundreds, or thousands of price classes. Further, price ranges may vary in size and number of unique prices contained therein. Nevertheless, a pricing process that corresponds to each price range is not necessarily unique from pricing processes of other price ranges. For instance, the pricing processes corresponding to two different price ranges may be the same.

Four example price ranges, which have contiguous upper and lower limits, are shown in the example method 200 of FIG. 2. The example ranges include a price range 222 from $0.01 to $5.00 (i.e., the lowest price range), a price range 224 from $5.01 to $50.00, a price range 226 from $50.01 to $500.00, and a price range 228 from $500.01 to $1,000.00. In some examples, each price range has a pricing process that acts to adjust the current price based on consumer survey data. In the example price range 222 involving current prices up to $5.00, for instance, a pricing process may reference a table to look up offer prices. In the example price range 224 involving current prices between $5.01 and $50.00, a pricing process may adjust the current price to the nearest $X.25. In the example price range 226 involving current prices between $50.01 and $500.00, for instance, a pricing process may adjust the current price to the nearest $5.00. Thus $63.97 would be adjusted to $65.00, for example. In the example price range 228 involving current prices between $500.01 and $1,000.00, for instance, a pricing process may adjust the current price to the nearest $10.00. Moreover, in some examples a highest price range may have an upper limit corresponding to the most expensive product offered by a merchant, while in other examples the upper limit of the highest price range may be an arbitrarily large number.

In some examples, offer prices that have been optimized by a class pricing process or a range pricing process can be multiples of denominations of currency of at least $0.05. In still other examples, offer prices are multiples of higher denominations, such as $0.10, $0.25, $1.00, $5.00, $10.00, and so on, for instance.

Once the system 100 has an offer price for the current price, whether from a pricing process based on a price class or a pricing process based on a price range, the system 100 may at a step 230 update the offer price data field of the database of the website content server 106 and/or the webpage to which the user is seeking access, which associates the offer price with the product, before ending the optimization process 232. Although the present disclosure refers to “the database,” those having ordinary skill in the art will understand that this terminology may very well mean updating a second database with the offer price. As those having ordinary skill in the art will further appreciate, the system 100 may run numerous iterations of this example method 200, or methods like it, to determine offer prices for a number of products.

Further, the system 100 may in some examples operate in a hybrid mode in which an current price belongs to both a price class and a price range. By way of example, where a current price belongs to a price class where the current price ends in $.99 and also belongs to a price range where the dollar amount falls between $0.XX and $9.XX, a pricing process may adjust the current price to the nearest dollar. As a further example, where a current price belongs to a price class where the current price does not end in $0.25 and also belongs to a price range where the dollar amount falls between $10.XX and $50.XX, a pricing process may adjust the current price to the nearest $0.25.

The system 100 also contemplates examples in which the pricing processes and offer prices are subject to overriding rules reflecting internal business rules, contractual obligations, accounting rules, etc., and configured either by default or by an operator of the system 100. For instance, one example rule may say that an offer price should under no circumstances be less than 10% of the current price. In the event that an offer price “breaks” this rule, the system 100 may use an alternative pricing process, such as adjusting to a smaller denomination (e.g., nearest $0.25 instead of nearest $1.00), to readjust. Another example rule may involve using an alternative pricing process where the initial adjustment generates an offer price that would result in the merchant being unprofitable. Of course, for each product for which such a rule could be implemented, the database would need a data field corresponding to the merchant's break-even sale price. Merchants can typically calculate such information based on quantities ordered and overhead costs. Other rules may reference data fields in the database, such as the minimum price at which a merchant will not offer to sell the product, for example, as disclosed above.

In still another example, example pricing processes are based on purchase patterns exhibited by consumers, as opposed to consumer survey data. For example, statistics regarding consumer purchase patterns may reveal a preference where consumers purchase higher quantities of product at $11.00 than at $10.50 or at $11.50, for instance. Data may be acquired, for example, by altering the price of the product over periods of time. In still other examples, though, example pricing processes are based on consumer survey data and consumer purchase patterns. Further, it will be understood by those having ordinary skill in the art that in some examples the original price may ultimately equal the offer price, particularly in examples where the original price is an optimal one (e.g., where the original price equals $1.00).

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

I claim:

1. A non-transitory computer readable media having stored thereon instructions which, when executed by a computer, perform steps comprising:
receiving a request from a user for an offer price of a product offered for sale;
retrieving a current price from a database, the current price being associated with a product offered for sale;
identifying a price range to which the current price corresponds, wherein the price range encompasses a series of prices between an upper limit and a lower limit;
executing a pricing process that computes an offer price based on the current price, wherein the pricing process is associated with the identified price range, the offer price being a multiple of a denomination of currency greater than or equal to $0.05;
associating the offer price with the product; and
providing the offer price to the user.

2. A non-transitory computer readable media as recited in claim 1, wherein the denomination of currency is greater than or equal to $0.10.

3. A non-transitory computer readable media as recited in claim 1, wherein the denomination of currency is greater than or equal to $0.25.

4. A non-transitory computer readable media as recited in claim 1, wherein the denomination of currency is greater than or equal to $1.00.

5. A non-transitory computer readable media as recited in claim 1, wherein the price range is selected from a plurality of price ranges, wherein other than a lower limit of a lowest price range and an upper limit of a highest price range, the plurality of price ranges have contiguous upper and lower limits.

6. A non-transitory computer readable media as recited in claim 1, wherein the pricing process is based on consumer survey data concerning product prices or purchase patterns exhibited by consumers.

7. A non-transitory computer readable media as recited in claim 6, further comprising recalculating the offer price based on supplemental consumer survey data.

8. A non-transitory computer readable media as recited in claim 1, wherein the product is offered for sale by a website; and
wherein the user is a user of the website.

9. A non-transitory computer readable media as recited in claim 8, further comprising updating the website to display the offer price associated with the product.

10. A non-transitory computer readable media as recited in claim 9, further comprising:
identifying the user of the website on which the product is offered; and
loading a pricing template that comprises a pricing process for each of a plurality of price ranges, the pricing template corresponding to at least one category of consumers with which the user of the website is associated.

11. A non-transitory computer readable media as recited in claim 12, further comprising:
generating a plurality of pricing templates based on consumer survey data; and
selecting the pricing template from the plurality of pricing templates, wherein the at least one category of consumers is based on at least one of gender, geographic region, industry type, income, or age of the user.

12. A non-transitory computer readable media having stored thereon instructions which, when executed by a computer, perform steps comprising:
receiving a request from a user for an offer price of a product offered for sale;
retrieving a current price from a database, the current price being associated with a product offered for sale;
identifying a price class to which the current price corresponds, wherein the price class encompasses a price class mask having at least one of a predetermined dollar value or a predetermined cent value;
executing a pricing process that computes an offer price based on the current price, wherein the pricing process is associated with the identified price class, the offer price being a multiple of a denomination of currency greater than or equal to $0.05;
associating the offer price with the product; and
providing the offer price to the user.

13. A non-transitory computer readable media as recited in claim 12, wherein the denomination of currency is greater than or equal to $5.00.

14. A non-transitory computer readable media as recited in claim 12, wherein the pricing process is based on consumer survey data concerning product prices or purchase patterns exhibited by consumers.

15. A non-transitory computer readable media as recited in claim 12, wherein the price class mask corresponds to the predetermined dollar value and the predetermined cent value.

16. A non-transitory computer readable media as recited in claim 12, further comprising:
identifying the user of the website on which the product is offered; and
loading a pricing template that comprises a pricing process for each of a plurality of price classes, the pricing template corresponding to at least one category of consumers with which the user of the website is associated.

17. A non-transitory computer readable media as recited in claim 12, wherein associating the offer price with the product comprises updating the database by storing the offer price in the database.

18. A non-transitory computer readable media having stored thereon instructions which, when executed by a computer, perform steps comprising:
receiving a request from a user for an offer price of a product offered for sale;
accessing a current price stored in a database, the current price being associated with a product or service being offered for sale;
identifying a price class and a price range to which the current price corresponds, wherein the price class is directed to at least one of a predetermined dollar value or a predetermined cent value, wherein the price range comprises a series of prices between an upper limit and a lower limit, the price class being related to the price range;
executing a pricing process that computes an offer price based on the current price, wherein the pricing process is associated with the price class and the price range, the offer price being a multiple of a denomination of currency greater than or equal to $0.05; and
providing the offer price to the user.

19. A non-transitory computer readable media as recited in claim 18, further comprising updating the database to associate the offer price with the product or the service.

20. A non-transitory computer readable media as recited in claim 18, wherein the pricing process is based on consumer survey data concerning product prices or purchase patterns exhibited by consumers.

21. A non-transitory computer readable media as recited in claim 20, further comprising recalculating the offer price based on supplemental consumer survey data.

22. A non-transitory computer readable media as recited in claim 20, further comprising identifying a user of a website on which the product or service is offered, wherein the pricing process that calculates the offer price is based at least in part on a category of consumers with which the user is associated.
